(19) United States
(12) Patent Application Publication
(10) Pub. No.: US 2002/0001980 A1
(43) Pub. Date: Jan. 3, 2002

(54) Electric plug system

(76) Inventor: Wolfgang Schmid, Langenargen (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/853,272

(22) Filed: May 11, 2001

(30) Foreign Application Priority Data
May 16, 2000 (DE) 100 24 029.1

(51) Int. Cl. H01R 33/00

(52) U.S. Cl. 439/34

(57) ABSTRACT

The electric plug system for the automatic transmission of a motor vehicle consists of a socket situated on the transmission and of a plug engaging in the socket wherein the cylindrical end (10) of the socket that accommodates the plug traverses a bore (3) in the transmission which is placed in the oil pan. The socket has a radial flange (5) to which attaches a cylindrical segment (6) of small diameter followed by the cylindrical end of a diameter still further reduced. The cylindrical end and the cylindrical segment are surrounded by a centering sleeve which by a locking system on the outer side of the oil pan can be firmly connected with the latter.

According to the preamble of claim 1, this invention concerns an electric plug system for the automatic transmissions of motor vehicles and consists of a socket and a plug that engages in the socket to create a connection between the electronic transmission control device situated in the transmission and the electric feed lines integrated in the wire harness of the motor vehicle.

Automatic transmissions for motor vehicles such as have been manufactured in large numbers by the Applicant have an electronic transmission control device or an electrohydraulic control often provided with an electronic module which is to be connected with a cable harness situated outside the transmission. The electric feed lines in the proximity of the electronic module within the transmission can be designed as flat lines connected, for example, with a socket of the electronic transmission control which is placed in the transmission housing after which the electric connection to the vehicle cable harness is created by plugging a matching plug.

The transmission wall usually is, at the same time, the dividing wall between the transmission control situated within the transmission housing and connected with a socket carrying electric contacts which is inserted in the transmission wall. The matching plug which is plugged in the socket is connected in circuit with the inputs and outputs of a control electronic system for monitoring and controlling the electronic system contained in the automatic transmission.

An electric plug system for the automatic transmissions of motor vehicles has been disclosed in DE U 297 21 908. In this plug system, the plug part is part of an electric plate from which the electric plug contacts pointedly project toward the wall of the transmission.

The plug contact arrangement is delimited by a web-like enclosing edge. The enclosing edge forms a seat for the front section of the plug socket part and for accommodating a guide sleeve. The guide sleeve is disposed projecting upwardly from the electric plate through the transmission wall and bordering on the inner side on the enclosing edge. The guide sleeve is connected with the enclosing edge by a clamp. By a segment having locking grooves on the outer side, the guide sleeve projects out of the transmission wall on the side opposite the electric plate. The locking grooves serve to lock a bayonet ring associated with the plug socket part to protect the electric plug system.

The bayonet ring has on its plugging side end a supporting flange which supports itself upon the outer surface of the transmission wall. The bayonet ring is designed so that when it is put on or is rotated to produce locking, the guide sleeve is to a determined extent drawn out of the transmission wall. When the bayonet ring is locked on the guide sleeve thereby determining drawing out of the guide sleeve or drawing the electric plate near the transmission wall, projections are forced into the centering and fastening bushes. After the bayonet ring is superposed, the electric plug connector and the electric plate belonging to the plug part are fastened on the transmission wall.

To ensure a perfect, long lasting operation of such a transmission, it is necessary to place the electric plate or the electric plug connector without play on the transmission wall, since transmission vibrations that occur can damage the elements that are movable against each other. To ensure such a fastening free from play of an electric plug system, it was proposed in DE 198 30 672 that the plug connector has an electric plug part carrying plug contacts, a guide sleeve connected with the plug part to grip through an assembly opening placed in one wall and an electric plug socket part containing contact bushes. After assembly the electric plug connector is situated without play in the assembly opening of the wall. To this end supports and a locking stop are associated with the guide sleeve upon the wall surface facing the plug socket. The locking stop has a distance from the underside of the support which is greater than the length of the assembly opening. Upon the locking stop of the guide sleeve supports itself a locking means which abuts on the other side on the surface of the wall opposite the support. In this manner the wall defining the assembly opening is braced between the support and the locking device. The locking device is movably disposed on the plug part for advancing the locking stop.

Even though it is thereby possible with simple means to obtain a tension-free assembly with simultaneous fastening free from play of the plug system on the transmission wall, here, the same as in the plug systems at present customary for automatic transmissions of motor vehicles, the socket is situated in the transmission housing in a place in which problems occur predetermined as result of the narrow installation space in the Cardan tunnel and the high temperatures that generate here due to the exhaust system.

The problem to be solved by this invention is to provide an electric plug system for automatic transmissions of motor vehicles which eliminates the problems associated with the small installation space and the high temperatures generated by the exhaust system, which is more accessible than the conventional plug systems and which is adequate as standard interface for the electric connection of the transmission with the control system in the motor vehicle for all types of vehicles known.

### SUMMARY OF THE INVENTION

It is also provided according to the invention that the plug system consisting of a socket situated in the transmission and of a plug engaging in the socket be constructed as follows:

the bore is provided in the oil pan and has on its upper outer edge a conical chamfer while in its underside is provided with an annular collar;

the socket is provided on its end facing the interior of the transmission with a radial flange having an outer diameter larger than the diameter of the bore in the oil pan and substantially equal to the outer diameter of the annular collar;

to the flange attaches a cylindrical segment having an outer diameter substantially equal to the diameter of the bore, there being provided in this segment an annular groove in which a seal engages;

to the cylindrical section attaches a cylindrical end that penetrates the bore and projects out of it, there being provided on the outer wall of the cylindrical end two locking gates opposite each other and each forming a guideway;

the cylindrical end and the cylindrical segment are surrounded by a centering sleeve having an outer diameter substantially equal to the diameter of the bore, the centering sleeve being provided on its outer side with an annular groove in which a seal engages;

the centering sleeve is provided with a locking clamp tiltably supported on it and having two guide pilots which interact with the locking gate on the cylindrical end and

the locking clamp acts together with a fixing device provided on the outer side of the oil pan.

The inventive electric plug system essentially refers to the design of the socket, which is placed in the oil pan and is in direct communication with the electronic transmission control within the transmission, offers the advantage of a simple construction at reasonable cost and an assembly without problem. The placing on the oil pan instead of on the transmission wall makes possible access without problem and protects it against unacceptable temperature increases.

### BRIEF DESCRIPTION OF THE DRAWING(S)

The invention is explained in detail herebelow with reference to the drawing in which an advantageous embodiment is shown. In the drawing:

FIG. 1 is an exploded representation of the separate parts and the coordination thereof in the area of the oil pan of an automatic transmission;

FIG. 2 said parts in assembled state;

FIG. 3a is a top view on the plug system with assembled locking clamp;

FIG. 3b is a top view with collapsed locking clamp;

FIG. 4a is a section through the socket connection, with assembly locking clamp;

FIG. 4b is a section with collapsed locking clamp;

FIG. 5a is a side view partly in perspective of a cut open plug systems shown assembled;

FIG. 5b is a side view partly in perspective of a cut open plug with collapsed locking clamp;

FIG. 6a is a partly cut out view of a plug system before assemblage with assembled locking clamp; and

FIG. 6b is a partly cut out view of a plug system in installed state with collapsed locking clamp.

In the figures the same parts have been provided with the same numerals.

### DETAILED DESCRIPTION OF THE INVENTION

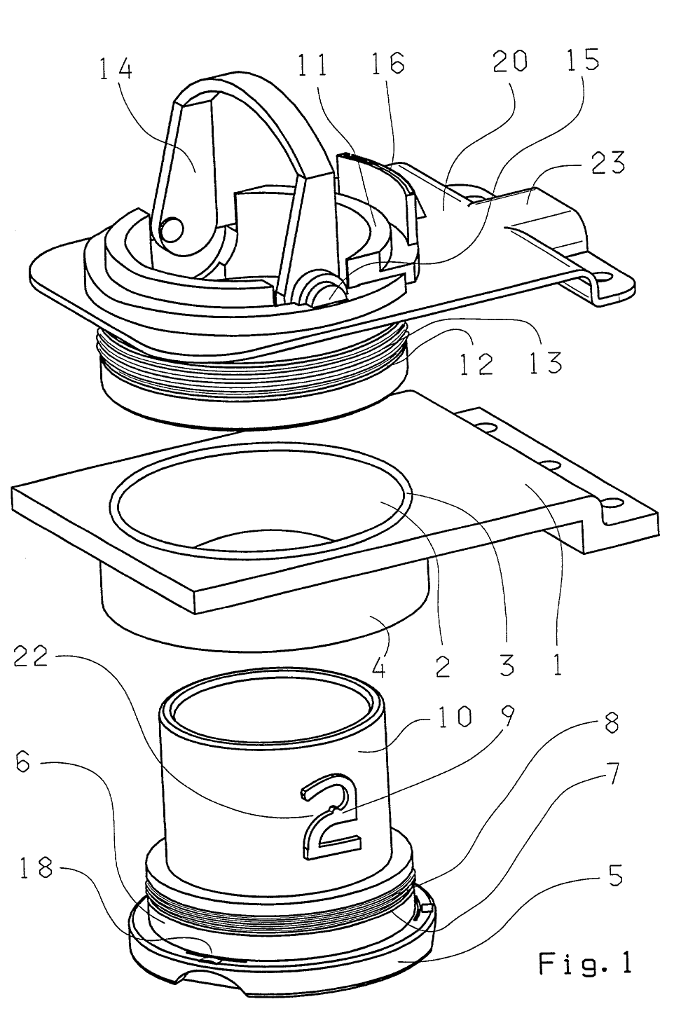

In the exploded drawing shown in FIG. 1 one part of the oil pan is designated with 1 and with 2 is designated a cylindrical bore provided in the oil pan which on its upper end is provided with a conical chamfer 3. With 4 is designated an annular collar attaching to the underside of the bore.

The socket to be introduced in the bore 2 has on its side facing the interior of the transmission an annular radial flange 5 having an outer diameter larger than the diameter of the bore 2 in the oil pan 1 and substantially equal to the outer diameter of the annular collar 4. To the flange 5 attaches a cylindrical section 6 having the outer diameter substantially equal to the diameter off the bore 2, there being provided in this cylindrical segment an annular groove 7 in which a seal 9 engages.

The socket to be introduced in the bore 2 has on its side facing the interior of the transmission an annular radial flange 5 having an outer diameter larger than the diameter of the bore 2 in the oil pan 1 and substantially equal to the outer diameter of the annular collar 4. To the flange 5 attaches a cylindrical segment 6 having its outer diameter substantially equal to the diameter of the bore 2, there being provided in this cylindrical segment an annular groove 7 in which a seal 8 engages.

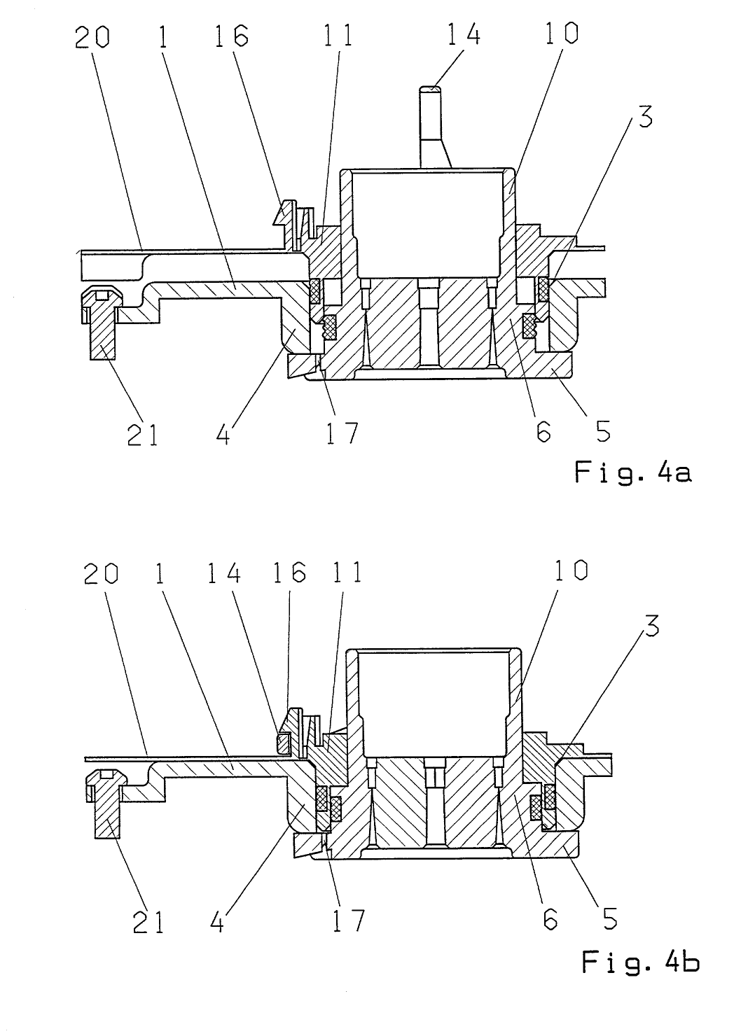

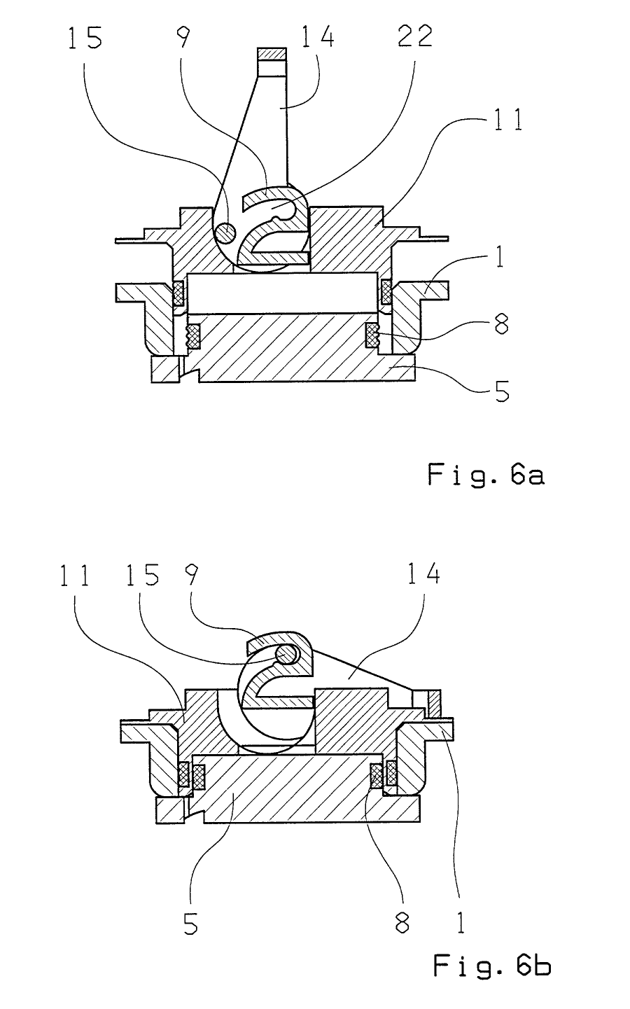

To the cylindrical segment 6 attaches a cylindrical end 10 having an outer diameter smaller than that of the cylindrical segment 6. On the outer wall of the cylindrical end 10 that traverses the bore 2 and projects out from it, two locking gates 9 opposite each other are provided each forming a guideway 22. The cylindrical end and the cylindrical segment 6 are surrounded in assembled state by a centering sleeve 11 having an outer diameter substantially equal to the diameter of the bore 2, the centering sleeve 11 having an annular groove 12 in which a seal 13 engages. The inner diameter of the centering sleeve 11 is designed stepped, the lower part of the centering sleeve abutting in assembled state on the cylindrical segment 6 and the upper part of the centering sleeve abutting on the cylindrical end 10. The lower edge of the lower part of the centering sleeve 11, which in assembled state abuts on the. flange 5, is preferably outwardly and inwardly chamfered (FIGS. 4 and 6).

The centering sleeve 11 is further provided with a locking clamp 14 which is tiltably supported thereon and has two guide pilots 15 which interact with the locking gates 9 on the cylindrical end 10, the locking clamp interacting with a fixing device 16 provided on the outer side of the oil pan 1.

The cylindrical bore 2 in the oil pan 1 is larger than the outer diameter of the inserted socket and has on its upper side a conical chamfer which facilitates the assemblage.

The radial flange 5 is preferably provided with a vent hole 17, as can be seen in FIGS. 4a and 4b. This also serves to facilitate the assemblage of the separate parts.

It is also advantageous that the radial flange 5 be provided with several tolerance compensating cams 18 on its upper side abutting on the annular collar of the oil pan.

The guideways 22 of the locking gates 9 have the shape of a 2 for a good sealing connection.

The fixing device 16 for the locking clamp 14 can be either a detent or a spring such as a flat spring or a leg spring insertable between the swivel axis for the locking clamp and one of the guide pilots 15 which engages in gate 9. designed so as to cover with a fishplate 23 at least one. connecting screw 21′ of the oil pan in assembled state.

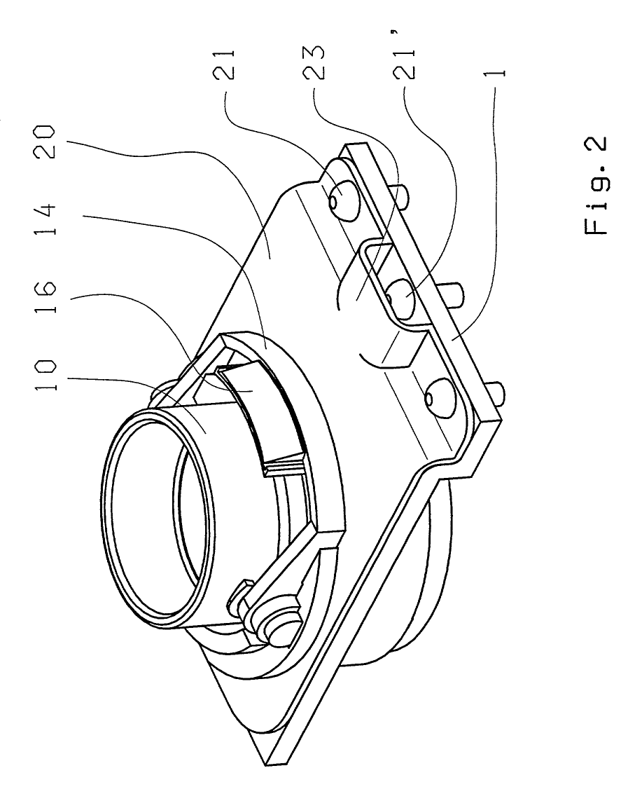

FIG. 2 shows an important part of the inventive plug system in assembled state, that is, the cylindrical end 10 projecting out of the bore and penetrating the oil pan 1 is locked by the collapsed locking clamp 14 in impermeable manner. The clamp 14 is here held in locking position by a detent 16. One of the screws 21′ for fastening the oil pan is covered by a fishplate 23 whereby is ensured that disassembly be possible only after the socket with the centering sleeve have been removed.

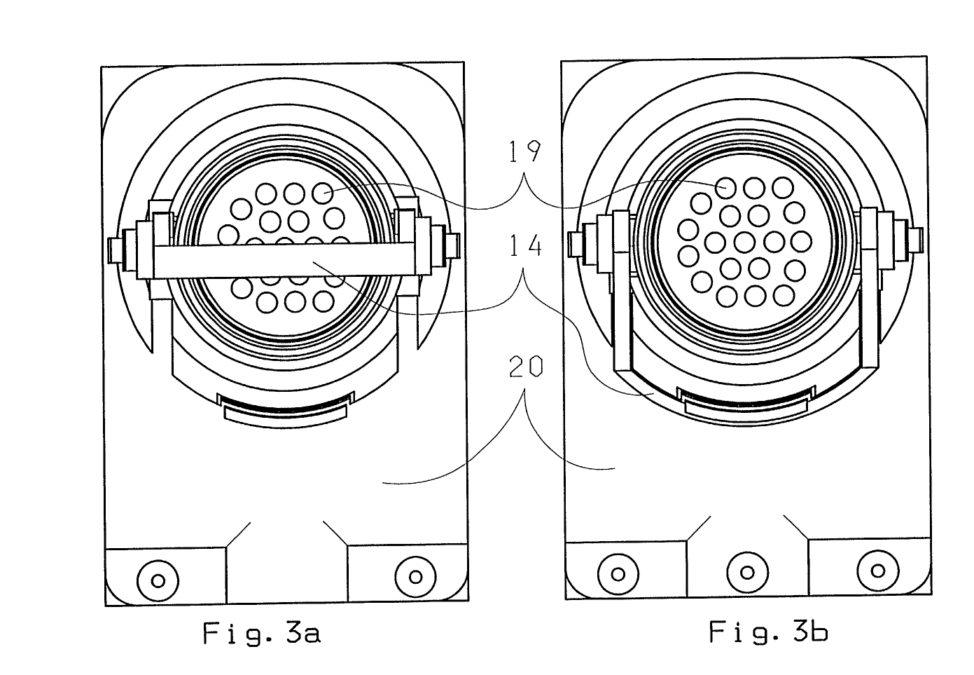

In the top views shown in FIGS. 3a and 3b, plug connections in the socket are designated with 19: these can here be retain bushes for the pins in the matching plug (not shown) or also electric pins which engage in corresponding retain bushes in the matching plug. In FIG. 3a is to be seen the locking clamp in assembled state and in FIG. 3b in collapsed position.

FIGS. 4a and 4b show sectional representations, wherein the socket is shortly before the final assemblage in FIG. 4a. There can be seen the locking clamp 14; in assembled state and the centering sleeve 11 still not fully inserted in the bore in the oil pan 1.

In FIG. 4b this insertion step has been terminated. The centering sleeve which surrounds both parts 6, 10 of the socket has been completely inserted and the projection 20 abuts on the upper side of the oil pan 1. The locking clamp 14 is collapsed and held in this position by the fixing device 16 here designed as detent.

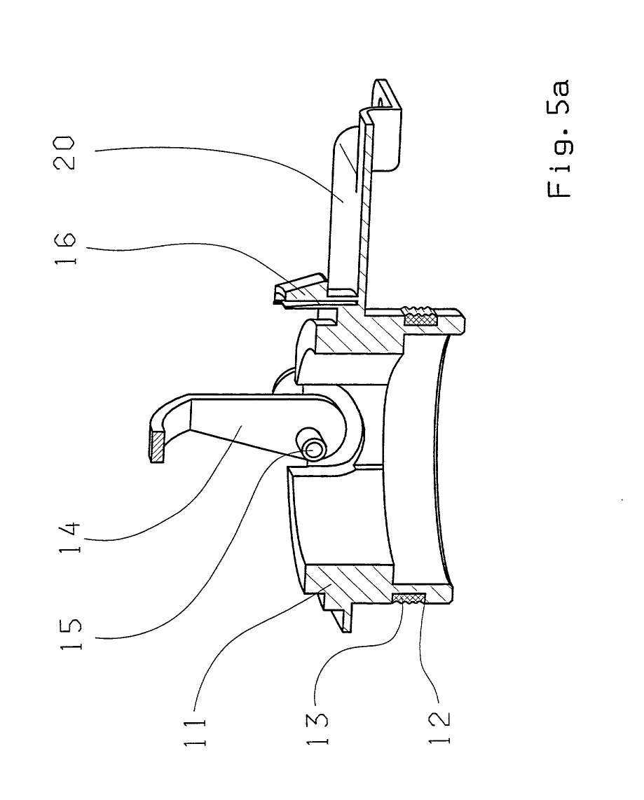

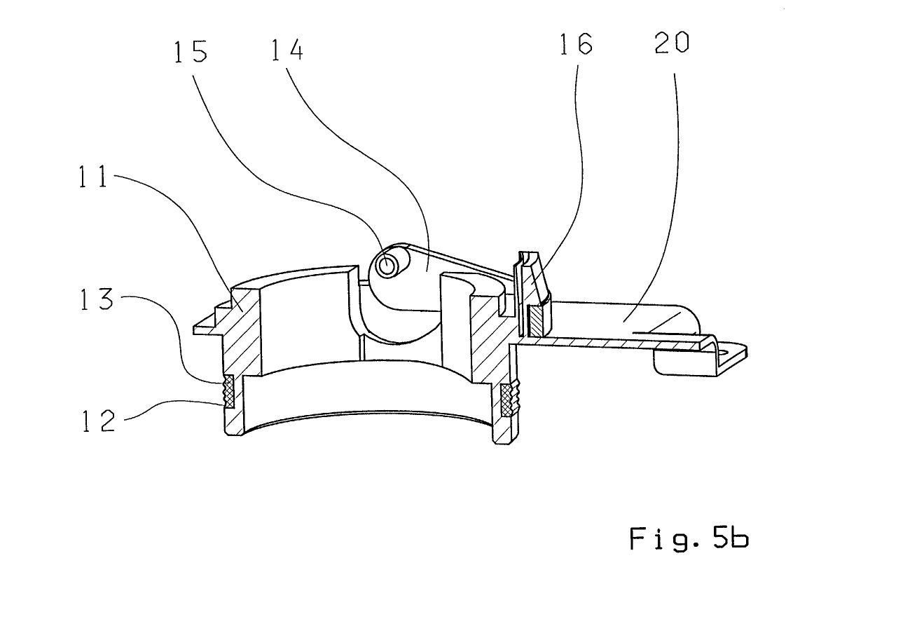

FIG. 5a shows the arrangement of the locking clamp 14 in the centering sleeve 11 which is cut out, the locking clamp 14 being in assembled position.

In FIG. 5b the locking clamp 14 is collapsed and again is held by the detent 16.

Instead of the detent, a spring can also be used as fixing device.

FIGS. 6a and 6b show two partly cut out and partly perspective views in order to represent the interaction of the locking clamp 14 together with the guide pilots l5 in the locking gate 9. In these two locking gates 9 lying opposite each other, guideways 22 are provided which, as can be seen in FIGS. 6a and 6b, have substantially the shape of a 2. When the clamp 14 is collapsed from the position shown in FIG. 6a to the position shown in FIG. 6b, a secure locking results due to the sliding along of the two guide pilots 15 into the corresponding part of the guideway 22 in the locking gates 9.

In a practical embodiment it has proved advantageous that the cylindrical bore 2 in the oil pan be larger by 10 mm than the outer diameter of the transmission socket with conical chamfer on the outer side. The socket is floatingly inserted in radial and axial direction in the mechatronic module. The seals in the centering sleeve and in the cylindrical segment can preferably be multi-lip sealing rings. The U-shaped locking clamp can be made of metal or plastic.

The assembly is as follows:

After the electric transmission control device together with the socket have been assembled in the transmission, the oil pan is superposed. By virtue of the large bore 2 provided in the oil pan, the latter can be assembled without danger of damaging the socket. After terminating the assemblage of the oil pan, a centering and sealing of the transmission socket is carried out for the centering sleeve. For this purpose, the centering sleeve is first slipped on the socket and then manually pushed against the bore of the oil pan. The lower edge of the centering sleeve is conically designed on the outer side so that during insertion in the bore of the oil pan the socket be radially aligned relative to the oil pan.

After the centering sleeve has been manually inserted as far as possible in the bore of the oil pan, there follows the force-locking between socket, centering sleeve and oil pan via the locking clamp which is here collapsed by 90° whereby the fixing device is locked. At least one fastening screw of the oil pan is simultaneously covered by a fishplate on the extension of the centering sleeve. This ensures that the oil pan can be disassembled only after removal of the centering sleeve. At least one more fastening screw traverses the extension of the centering sleeve and connects it firmly with the oil pan.

In assembled state said plug system is now ready to accommodate a matching plug (not shown) inserted in the cylindrical end of the socket.

Reference numerals

1 oil pan

2 bore

3 chamfer

4 collar

5 flange

6 cylindrical segment

7 groove

8 seal

9 gate

10 cylindrical end

11 centering sleeve

12 groove

13 seal

14 locking clamp

15 guide pilot

16 fixing device

17 vent hole

18 cam

19 contract

20 lengthening piece

21 fastening screw

22 guideway

23 fishplate

1. Electric plug system for the automatic transmissions of motor vehicles consisting of a socket situated in the transmission and of a plug engaging in the socket for creating a connection between the electronic control device situated in the transmission and electric feed-in lines integrated in the cable harness wherein the cylindrical end of the socket that accommodates the plug traverses a bore in the transmission and is held by a detachable locking system, characterized in that
a) said bore (2) is provided in said oil pan (1), that it has on its upper outer edge a conical chamfer (.3) and that it is provided on its underside with an annular collar (4);
b) said socket has on its end facing the interior of the transmission a radial flange (5) having an outer diameter larger than the diameter of said bore (2) in said oil pan (1) and substantially equal. to the outer diameter of said annular collar (4);
c) to said flange (5) attaches a cylindrical segment (6) having an outer diameter substantially equal to the diameter of said bore (2) and that in said segment is provided an annular groove (7) in which a seal (8) engages;
d) to the cylindrical segment (6) attaches the cylindrical end (10) wherein on the outer wall of the part of said cylindrical end (10) that traverses said bore (3) and projects out of it, two locking gates (9) are provided which are opposite each other and each forms a guideway (22);
e) said cylindrical end (10) and said cylindrical segment (6) are surrounded by a centering sleeve (11) having its outer diameter substantially equal. to the diameter of said bore (2) and that said centering sleeve (11) is provided on its outer side with an annular groove (12) in which a seal (13) engages;
f) said centering sleeve (1 1) is provided with a locking clamp (14) tiltably supported on said sleeve and having two guide pilots (15) that interact with said locking gates (19) on said cylindrical end (10); and
g) said locking clamp (14) interacts with a fixing device (16) provided on the outer side of said oil pan (1).
g) said locking clamp (14) interacts with a fixing device (16) provided on the outer side of said oil pan (1).

2. Plug system according to claim 1, characterized in that said radial flange (5) is provided with a vent hole (17).

3. Plug system according to claims 1 and 2, characterized in that said radial flange is provided with several tolerance compensating cams (18) on its upper side abutting on the underside of said collar (4) of said oil pan (1).

4. Plug system according to any one of the preceding claims, characterized in that said guideways (22) of said locking gates (9) have the shape of a 2.

5. Plug system according to any one of the preceding claims, characterized in that said fixing device (16) is a detent for said locking clamp (14).

6. Plug system according to any one of the preceding claims, characterized in that said fixing device (16) for said locking clamp (14) is a spring situated between said guide pilots (15) and the swivel axis for said locking clamp (14).

7. Plug system according to any one of the preceding claims, characterized in that said centering sleeve (11) is provided with a lengthening piece (20) which extends at least up to a fastening screw (21) for said oil pan.

8. Plug system according to any one of the preceding claims, characterized in that said lengthening piece (20) is shaped so as to cover via a fishplate at least one fastening screw (21′) for said oil pan in the assembled state of said socket.
